(19) United States
(12) Patent Application Publication
(10) Pub. No.: US 2013/0117167 A1
(43) Pub. Date: May 9, 2013

(54) INTELLECTUAL ASSET TIME AND EXPENSE ENTRY MANAGEMENT

(71) Applicant: ANAQUA, INC., Boston, MA (US)

(72) Inventors: Priya Iyer, Wellesley, MA (US); Kelly Crawford, Sundance, WY (US); David Bartle, Acton, MA (US); Denise Cheung, Wellesley, MA (US)

(73) Assignee: ANAQUA, INC., Boston, MA (US)

(21) Appl. No.: 13/667,056

(22) Filed: Nov. 2, 2012

Related U.S. Application Data
(63) Continuation-in-part of application No. 13/448,166, filed on Apr. 16, 2012.
(60) Provisional application No. 61/555,509, filed on Nov. 4, 2011.

(51) Int. Cl. G06Q 40/00

(52) U.S. Cl. CPC G06Q 40/105
USPC 705/32

(57) ABSTRACT

Example embodiments relate to time and expense entry management for intellectual asset records. An example embodiment includes a method of creating a time/expense entry for an intellectual asset record stored within an intellectual asset management system. The method includes detecting closure of a task associated with an intellectual asset record and comparing a task type of a time/expense template to the closed task. The method additionally includes determining a match of the task type to the task, and in response to determining the match, creating a time/expense entry for the intellectual asset record.

### CROSS-REFERENCE TO RELATED APPLICATIONS

This application is a continuation-in-part of application Ser. No. 13/448,166, filed on Apr. 16, 2012, and this application also claims the benefit of and priority to U.S. Provisional Application No. 61/555,509, filed on Nov. 4, 2011—each of these applications is incorporated herein by reference.

### TECHNICAL FIELD

The present application relates generally to time and expense entry management. More particularly, the application relates to time and expense entry management for intellectual asset records.

### BACKGROUND

An intellectual asset management (IAM) system is used to schedule legal matters and manage aspects of intellectual property assets. Examples of intellectual property assets may include: patents, trade secrets, publications, trademarks, domain names, copyrights, and applications or filings thereof. An IAM system may support docketing and other related activities in the full lifecycle of intellectual property assets, such as invention disclosure submission, trademark search requests, multi-party collaboration, document and e-mail management, configurable business workflow rules, and business intelligence tools, among other features. An IAM system provides visibility and access to internal and external participants in the intellectual asset management process—for example, attorneys, agents and paralegals, researchers and engineers, portfolio managers, marketing, licensing professionals and other business managers.

A challenge facing IAM users of intellectual asset management systems is tracking time and expenses associated with work pertaining to an intellectual asset, with this work sometimes being performed on behalf of a client entity. As an example, a patent practitioner may need to keep track of completed tasks, billing rates, and patent office fees during prosecution of a patent application with the patent office on behalf of a client entity. In some instances, the patent practitioner may charge some client entities a fixed monetary amount for drafting and filing a patent application in a given jurisdiction, while in other instances the patent practitioner may instead charge an hourly rate, where the hourly rate is dependent upon the client entity on whose behalf the practitioner is working. Additionally, the patent practitioner may utilize assistance from one or more paralegals to perform the patent application filing and may wish to charge a fee or hourly rate for such paralegal work.

### SUMMARY

Embodiments relate generally to time and expense entry management. More particularly, some embodiments relate to time and expense entry management for intellectual asset records. In one example embodiment, a method of creating a time/expense entry for an intellectual asset record stored within an intellectual asset management system is provided, wherein the method includes detecting closure of a task associated with the intellectual asset record, comparing a task type of a time/expense template to the task, determining a match of the task type to the task, and in response to determining the match, creating a time/expense entry for the intellectual asset record. The method may further include utilizing one or more time/expense template units, in addition to the task type, in creation of the time/expense entry. The one or more time/expense template units may include at least one of an expense, a billing rate, and an additional action, and the billing rate may include an amount to charge for services rendered in performance of the task matched to the task type of the time/expense template. Additionally, the method may further include performing one or more predetermined additional steps upon closure of the task, as defined by the additional action, and the one or more predetermined additional steps may be further determined by at least one of an intellectual asset type, a client, and the service performer. Moreover, the time/expense entry for the intellectual asset record may include at least one of a recorded time, a service performer, a completed service, an incurred expense, a total, a billable amount, and a paid amount. The method may also further include calculating the total using the billing rate, wherein the billing rate is based upon at least one of an intellectual asset type, a client, and the service performer. Furthermore, the method may also further include constructing a bill using values from the time/expense entry, and may also include sending the bill to a client entity or designating that the bill requires review.

In an example embodiment, an intellectual asset management server comprising at least one memory device for storing one or more intellectual asset records and a controller operatively connected to the at least one memory device is provided. The docketing server controller may detect closure of a task associated with an intellectual asset record, compare a task type of a time/expense template to the task, determine a match of the task type to the task, and in response to determining the match, create a time/expense entry for the intellectual asset record. In some example embodiments, the controller further utilizes one or more time/expense template units, in addition to the task type, in creation of the time/expense entry. The one or more time/expense template units may include at least one of an expense, a billing rate, and an additional action, and the billing rate may include an amount to charge for services rendered in performance of the task matched to the task type of the time/expense template. Also, in some example embodiments, the controller further performs one or more predetermined additional steps upon closure of the task, as defined by the additional action. The time/expense entry for the intellectual asset record may include at least one of a recorded time, a service performer, a completed service, an incurred expense, a total, a billable amount, and a paid amount. Additionally, the controller may further calculate the total using the billing rate, wherein the billing rate is based upon at least one of an intellectual asset type, a client, and the service performer.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the claimed subject matter will be set forth in the description which follows, and in part will be obvious from the description, or may be learned by the practice of embodiments. The features and advantages of various embodiments may be realized and obtained by means of the instruments and combinations particularly pointed out in the appended claims. These and other features of example embodiments will become more fully apparent from the following description and appended claims, or may be learned by the practice of embodiments as set forth hereinafter.

### BRIEF DESCRIPTION OF THE DRAWINGS

To further clarify the above and other advantages and features of the present application, a more particular description the subject matter of this application will be rendered by reference to specific embodiments thereof which are illustrated in the appended drawings. It is appreciated that these drawings depict only example embodiments and are therefore not to be considered to limit scope of the present application. Example embodiments will be described and explained with additional specificity and detail through the use of the accompanying drawings in which:

FIG. 1A illustrates an example IAM system including an example IAM server;

FIG. 1B illustrates an example IAM server of the IAM system of FIG. 1A;

FIG. 2 illustrates example data that may be stored as part of an intellectual asset record on the IAM server of FIG. 1B;

FIG. 3 is a block diagram illustrating an example user interface object that may be included in the IAM system of FIG. 1A and that provides details on tasks associated with an intellectual asset record;

FIGS. 4A and 4B are block diagrams depicting an example user interface object used to close an open task associated with an intellectual asset record;

FIG. 5 illustrates an example time/expense template;

FIG. 6 illustrates an example time/expense entry;

FIG. 7 illustrates an example method for automatically creating time and/or expense entries upon closure of a task associated with an intellectual asset record; and

FIG. 8 illustrates a block diagram illustrating a suitable computing environment in which several embodiments may be implemented.

### DETAILED DESCRIPTION

Embodiments relate generally to time and expense entry management. More particularly, some embodiments relate to time and expense entry management for intellectual asset records.

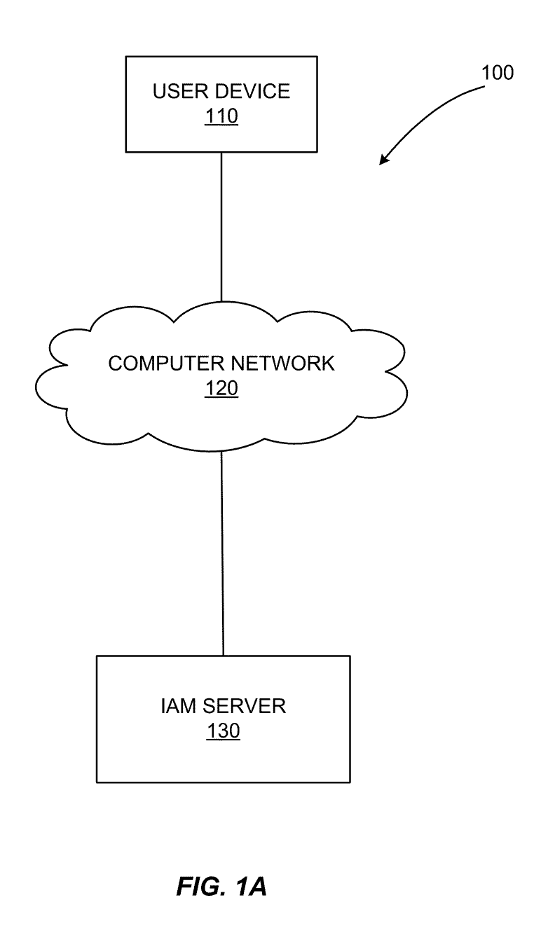

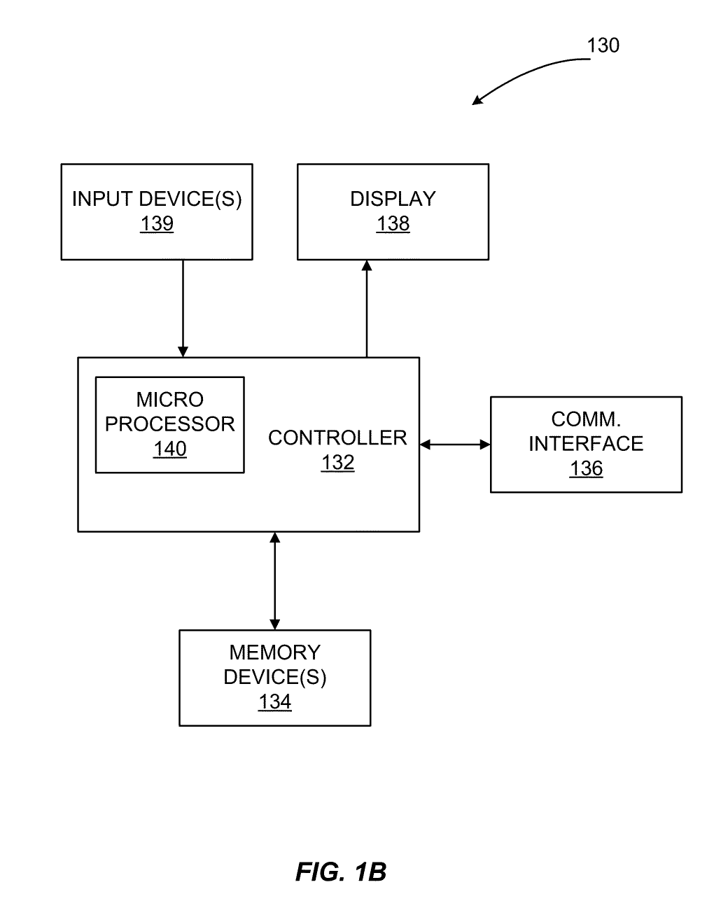

FIG. 1A illustrates an example IAM system 100. The IAM system 100 generally provides one or more IAM users (not shown) with an IAM service (not shown). The IAM system 100 may include a user device 110 communicatively coupled to an IAM server 130 via a computer network 120. The coupling between the IAM server 130 and the user device 110 may enable the IAM user to access at least some portion of an IAM service stored or otherwise available on the IAM server 130.

The IAM service may generally schedule legal matters pertaining to intellectual assets and manage aspects of those legal matters. For example, an intellectual property docking service may support scheduling a disclosure submission and manage the related filing dates such as provisional application filing, non-provisional conversion dates, maintenance fees, and the like. The management and scheduling of these legal matters may be managed by an IAM server application (described below) which may include a set of templates, data, instructions, applications, computer programs, or some combination thereof. Alternatively or additionally, the IAM system 100 may provide a visible and accessible, user interface to internal and external entities through which the legal matters are managed. Specifically, as described herein, the IAM service may include various IAM server applications that include one or more user interface (UI) objects, for instance, to enable the IAM user to manage time and expense entries.

The user device 110 in FIG. 1A may be a desktop computer, a laptop computer, a portable electronic device such as a cellular/mobile/smart phone, a tablet personal computer, a personal digital assistant, or any equivalent type of device. The user device 110 may include IAM client software to access the IAM server 130, or the user device 110 may include a web browser to access the IAM server 130, where the IAM server 130 provides the IAM service as a web application. Alternatively, the user device 110 may communicate with the IAM server 130 through other means, such as a remote desktop connection.

Additionally, the user device 110 communicates with the IAM server 130 via the computer network 120. The computer network 120 relates to a collection of devices interconnected by communication channels that allows sharing of information among the interconnected devices. In this example embodiment, the computer network 120 may be or include any wired or wireless network technology such as optical fiber, electrical cables, Ethernet, radio wave, microwaves, infrared transmission, wireless internet, communication satellites, cellular telephone signals, or an equivalent networking signal that interfaces with devices to create network. Specifically, in one embodiment, the user device 110 communicates with the IAM server 130 via the internet. In other embodiments, the user device 110 may be directly coupled with the IAM server 130 and/or may be integrated directly with, and be a part of, the IAM server 130.

In FIG. 1A, one user device 110 is operably connected to communicate with the IAM server 130 via the computer network 120. However, in alternative embodiments a plurality of user devices 110 which may include various types of user devices 110 may simultaneously communicate with the IAM server 130. Additionally or alternatively, the IAM system 100 may include multiple IAM servers 130 which are operably connected to communicate information among the multiple IAM servers 130 and/or to communicate information among various user devices 110 operably connected to communicate with the IAM servers 130.

FIG. 1B illustrates additional details of the IAM server 130 of FIG. 1A. As depicted in FIG. 1B, the IAM server 130 may include a controller 132 and a memory device 134. The controller 132 may include a microprocessor 140 which executes an IAM server application (not shown). The IAM server application may include templates, data, instructions, applications, or computer programs stored in the memory device 134. The IAM server application may vary as necessary to implement the IAM service.

In the embodiment illustrated in FIG. 1B, the controller 132 is operatively coupled to the memory device 134, which enables the controller 132 through the microprocessor 140 to access information stored on the memory device 134 such as the IAM server applications, an intellectual asset record (IA record) (described below), and/or a file (described below). The memory device 134 may provide data to the controller 132 in various forms, such as, but not limited to, database records, files, bitstreams, and bytestreams, and the memory device 134 may comprise volatile or non-volatile memory or storage.

As depicted in FIG. 1B, the docket server 130 can include a single controller 132, which can include a microprocessor 140 that executes an IAM server application, and a single memory device 134. However, in alternative embodiments, the docket server 130 may include one or more controllers 132, one or more microprocessors 140 which execute a plurality of IAM server applications, and one or more memory devices 134. The one or more memory devices 134 may be remotely located from each other and/or from the controller 132.

The IAM server 130 can include a communication interface 136. The communication interface 136 enables the IAM server 130 to communicate with a user device via a computer network. For example, with combined reference to FIGS. 1A and 1B, the communication interface 136 may enable the user device 110 to communicate to the IAM server 130 via the computer network 120. Additionally, the communication interface 136 may enable the IAM server 130 to communicate with other IAM server applications either publically or privately available on the internet or through an interface between multiple IAM servers 130, which are operably connected via the computer network 120. Examples of the communication interface 136 include any receiver or transmitter capable of functioning with the computer network 120.

Referring back to FIG. 1B, the IAM server 130 may further include a display 138 and one or more input devices 139. The IAM user (not shown) and/or an IAM server administrator (not shown) may directly interface and control the IAM server 130 through the display 138 and the input devices 139. Examples of the display 138 may include a thin film transistor liquid crystal display, liquid crystal display, or an equivalent structure. Examples of the input devices 139 may include a QWERTY key pad, a ten key input pad, a mouse, a stylus, voice recognition software, an audio mixer, or may be integrated with the display 138 as in a touchscreen device using a surface acoustic wave, surface capacitance, projected capacitance, or an equivalent structure.

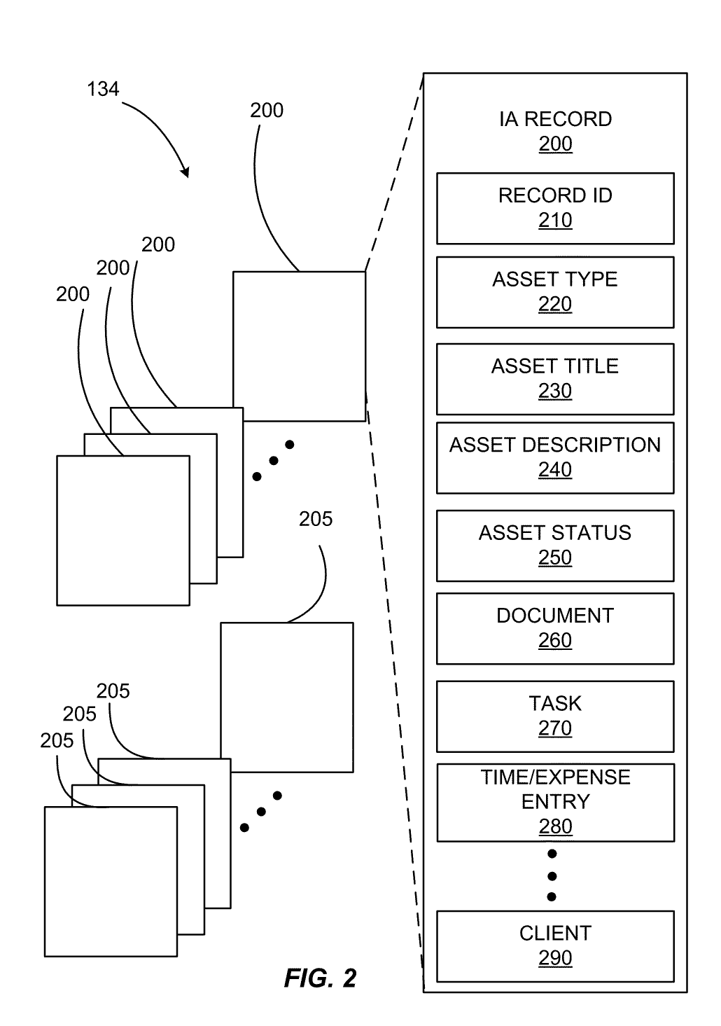

Turning next to FIG. 2, additional details of the memory device 134 of FIG. 1B are disclosed. FIG. 2 illustrates data that may be stored in the memory device 134. Specifically, in some embodiments the data may include intellectual asset records (IA record) 200 and/or files 205. The files 205 may include one or more of any type of computer file readable by one or more computer programs, and examples of the files 205 include one or more of: text files; image files such as PNG, GIF, JPG, etc.; PDF files; etc.

In alternative embodiments, the files 205 and the IA records 200 may be stored separately. For example, the files 205 may be stored on a first memory device and the IA records 200 may be stored on a second memory device. In this and other example embodiments, the first memory device may be located in an IAM server such as the IAM server 130 of FIG. 1B and the second memory device may be located in a remote site. Alternatively, the files 205 and the IA records 200 may both be stored on a single memory device 134. Additionally or alternatively, other data may be stored in the memory device 134 including but not limited to IAM server applications, networking information, IAM user demographic or statistical information, IAM server administrator permissions, etc.

FIG. 2 further illustrates potential contents of the IA records 200. Generally, the IA records 200 include a set of related data organized into units which pertain to an intellectual asset such as a patent, a trademark, copyright, or the like. For example, the set of related data of the IA records 200 may be organized into the units including a record identifier 210, an asset type 220, an asset title 230, an asset description 240, an asset status 250, a document 260, a task 270, time/expense entry 280, and a client 290. Each of these units will be briefly discussed below.

With respect to the embodiment illustrated in FIG. 2, the record identifier 210 is an identifier uniquely identifying the IA record 200 and can be used to reference the IA record 200. The asset type 220 may be used to distinguish between various types of intellectual assets, such as patents, trademarks, copyrights, trade secrets, etc. The asset title 230 may provide a name for the IA record 200, and the asset description 240 may provide a summary of the IA record 200. The asset status 250 may indicate the current status such as pending, abandoned, issued, etc. of the intellectual asset associated with the IA record 200.

The document 260 may be associated with the IA record 200 to supplement information stored in the IA record 200. Examples of the document 260 may include but are not limited to an archive, a record, a report, a paper, an article, a reference, a response, an action, a correspondence, a memorandum, an audio recording, a video recording, a photo, or a drawing. The document 260 is associated with the IA record 200 by being linked to the IA record 200. The link between the IA record 200 and the document 260 can be implemented through various techniques which may include, storing in the IA record 200 a file path to the document 260, storing in the IA record 200 a database reference to the document 260, or the like. Additionally, the document 260 may be stored within the IA record 200 as illustrated in FIG. 2 or alternatively, the document 260 may be stored separately from the IA record 200.

In the embodiment illustrated in FIG. 2 there is one document 260 associated with the IA record 200. However, there may be a plurality of documents 260 which may include various examples listed above. Additionally or alternatively, the plurality of documents 260 may be associated with one IA record 200, the plurality of documents 260 may be associated with multiple IA records 200, or some subset of the plurality of documents 260 may be associated with one or more IA records 200 within the IAM system 100 (FIG. 1A). Once the file 205 is associated with the IA records 200, the file 205 is also referred to as the document 260.

Generally, the task 270 denotes an action for a specified IAM user to complete by a specified time. Some examples of the task 270 may include but are not limited to instructing outside counsel, attending meetings, etc. Like the document 260, the task 270 may be a plurality of tasks 270. That is, multiple tasks 270 may be, and commonly are, associated with the IA record 200.

The time/expense entry 280 denotes recorded hours, service performer, completed services, and/or incurred expenses associated with the intellectual asset 200. The time/expense entry 280 may include other details such as which of the recorded hours, completed services, and incurred expenses are billable to a client entity Like the task 270, the time/expense entry 280 may be a plurality of time/expense entries 280. That is, multiple time/expense entries 280 may be, and commonly are, associated with the IA record 200. The time/expense entry 280 may include a set of related data which may be organized into units that may include any subset of those units listed above or may include various others not listed. For example, an embodiment of a time/expense entry 280 may include recorded hours, while omitting incurred expenses.

The client 290 denotes a client entity (not shown), whether an individual or organization, on whose behalf services are performed for the intellectual asset referenced by the IA record 200. The client 290 may be a plurality of clients 290. That is, multiple clients 290 may be associated with the IA record 200.

As stated above with reference to FIG. 1A, the IAM system 100 enables the user device 110 to access the IAM server 130 to obtain the IAM service. Some example solutions for accessing the IAM server 130 include IAM client software and/or a web browser loaded on the user device 110. Alternatively, the user device 110 may communicate with the IAM server 130 through a remote desktop connection. In embodiments with the web browser, the IAM server 130 provides the IAM service as a web application.

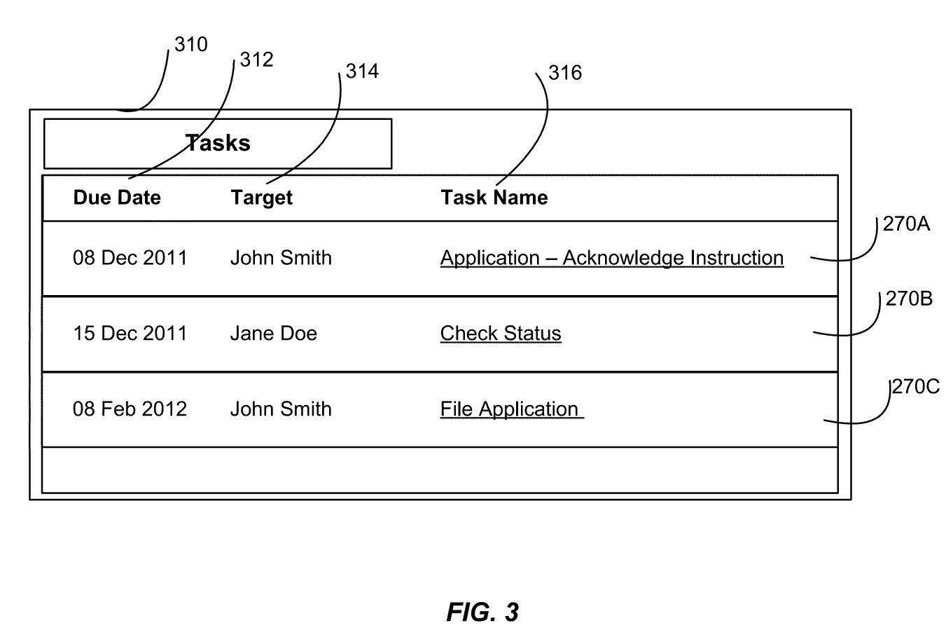

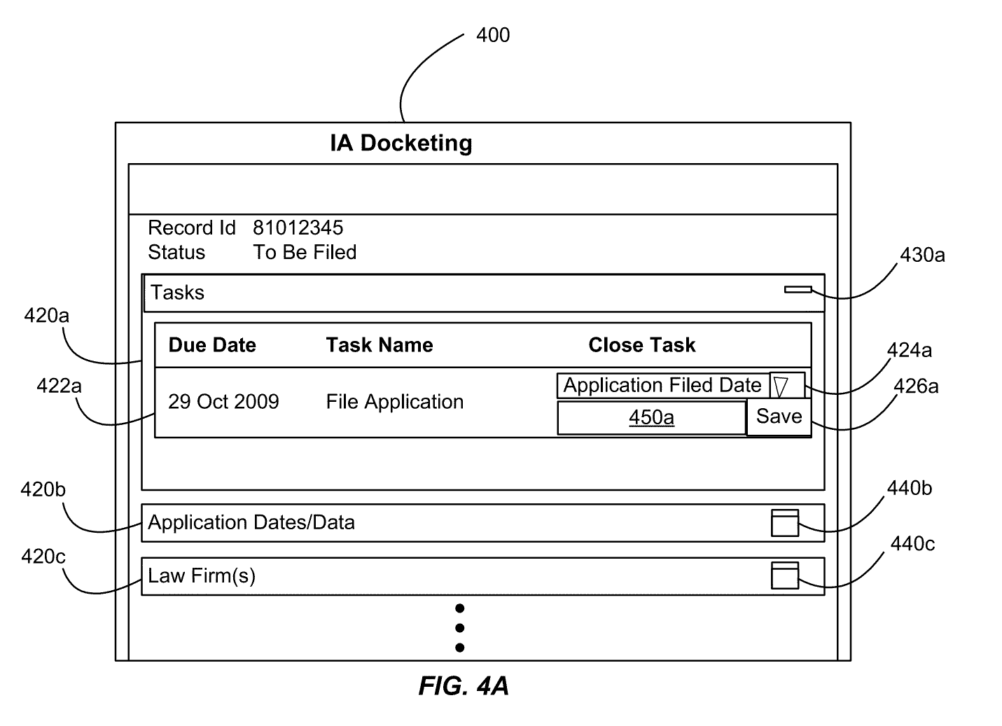

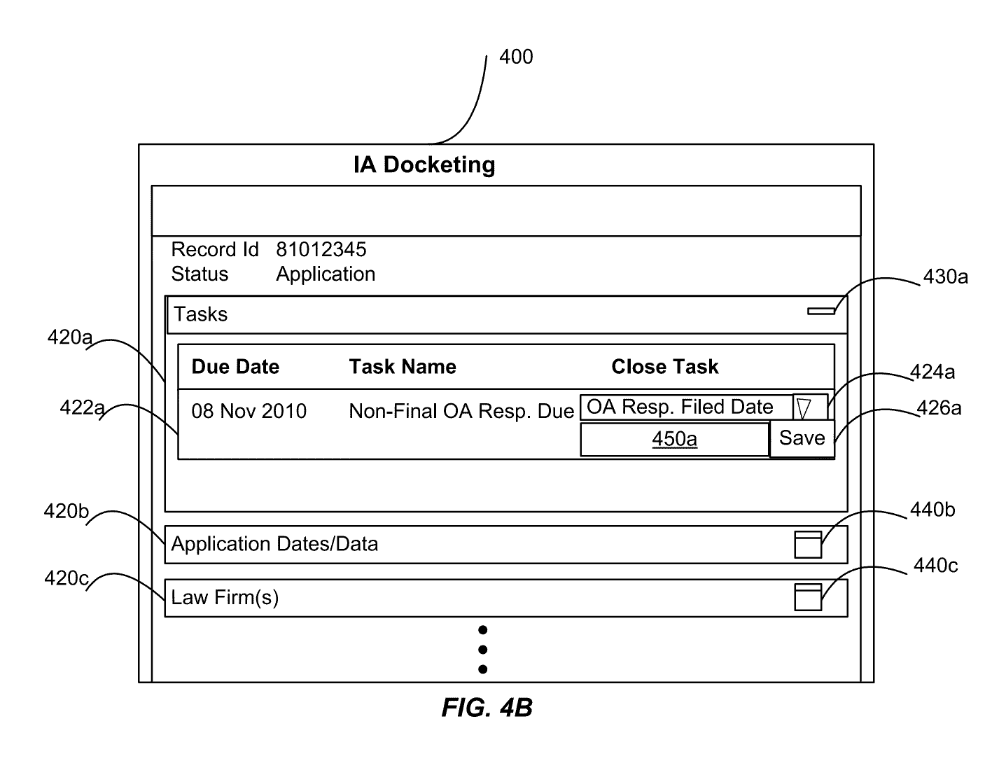

To provide the IAM service, examples of the IAM system 100 may allow the IAM user to interface with the IAM server 130. The interface between the IAM user and the IAM server 130 may utilize user interface (“UI”) objects. The UI objects provide the IAM user information related to a specific unit such as the task 270 (FIG. 3). Additionally or alternatively the set of UI objects may allow the IAM user to modify the information contained in the units such as the task 270 (FIGS. 4A and 4B).

Depending on the configuration of the IAM system 100, the UI objects may be created and provided to the IAM user differently. For example, the UI objects may be created by the IAM server 130 and may be provided to the web browser loaded on the user device 110. In this embodiment, the web browser renders the UI objects which may be described in HTML, JavaScript, CSS or an equivalent language. In alternative embodiments, the UI objects may be implemented as a dedicated client on the user device 110 or the UI objects may be implemented by the IAM user interfacing directly with the IAM server 130.

Turning next to FIG. 3, details of a task list UI object 310 are disclosed. As illustrated in FIG. 3, the task list UI object 310 provides details on the tasks 270 (illustrated as a first task 270A, a second task 270B, and a third task 270C) associated with the IA record 200. For example, the task list UI object 310 may display information, referred to generally as values, related to the task 270 such as a due date value 312, a target value 314, and a task name value 316. Ultimately, the task list UI object 310 relates information with an action that is to be accomplished. The action may be specifically described by the task 270 in a docketing schedule (not shown). The task 270 can be created by the IAM user or automatically by the IAM server 130 according to predefined workflow rules.

In the example third task 270C provided in FIG. 3, the due date value 312 is Feb. 8, 2012; the target value 314 is John Smith; and the task name value 316 is “File Application”. In this example, the above values mean that John Smith needs to file an intellectual asset application, which could be, for example, a patent application or trademark application, by Feb. 8, 2012 for the intellectual asset associated with the IA record 200. In the above example, the action is what John Smith needs to do, that is, “file an application” which may be described by the task 270 in John Smith's docketing schedule.

FIG. 4A is a block diagram depicting an example docketing UI object (docketing interface) 400. In some embodiments, the docketing interface 400 may provide the IAM user with, for example, details on docketing metadata for a first IA record 200. Additionally, the docketing interface 400 may enable the IAM user to manage docketing metadata for the first IA record 200. The docketing interface 400 may be defined, controlled, displayed, or some combination thereof, by the IAM server 130. The controller 132 of the IAM server 130 may display UI objects through the user device 110 for interaction with the IAM user. In some embodiments, the controller 132 may also utilize client-side scripting at the user device 110 to make user interaction more responsive. In some embodiments, the docketing interface 400 may be a subcomponent of a parent interface or a superset UI object (not shown), such as an encompassing parent window.

The docketing interface 400 may include numerous UI objects. Some of the UI object may relate to contents of the IA records 200. For example, for the first IA record 200, the record identifier 210 has a value of ‘81012345’, and the asset status 250 has a value of “To Be Filed”.

A plurality of movable intellectual asset docketing panels 420, wherein each panel of the plurality of panels 420 comprises a plurality of related fields 422, is included within the docketing interface object 400. For example, panel 420a comprises a plurality of fields related to tasks and prosecution items, panel 420b comprises a plurality of fields related to application dates and data, and panel 420c comprises a plurality of fields related to law firms. Including three panels within FIG. 4A is for illustrative purposes only, as the docketing interface object 400 may comprise any number of panels 420. Each panel 420 also comprises one of a minimize panel UI object 430 and a maximize panel UI object 440. For example, panel 420a includes the minimize panel UI object 430a because panel 420a is displayed maximized, and panels 420b and 420c include the maximize panel UI objects 440b and 440c, respectively, as panels 420b and 420c are each minimized.

The plurality of fields 422a in this example for the IA record 200 and the tasks and prosecution items panel 420a comprises a due date field, a task name field, and a close task field. The values for the due dates field and the task name field in the example of FIG. 4A are ‘29 Oct. 2009’ and ‘File Application’, respectively, indicating for the task 270 that the task target should file an application by Oct. 29, 2009. The IAM user can utilize the close task field to enter a date into a metadata entry area 450 of the field with a selected type of date chosen using a drop-down 424, where in this example the drop-down 424 provides for selection of a type of important date. In FIG. 4A, for the tasks and prosecution items panel 420a, the IAM user may enter a date into the date metadata entry area 450a, leave the drop-down 424a to a default date type value, or choose another date type value from the drop-down 424a, and lastly select a save metadata UI object 426, in this example 426a, to save a date entered into the metadata entry area 450a and then close the task 270. Additionally or alternatively, the task 270 may be closed in response to an IAM user entering metadata other than a date, and the task 270 may be closed in response to any other event recognized by the IAM server 130.

The IAM server 130 advantageously derives the drop-down 424 and the metadata entry area 450 to display in the Tasks and Prosecution Items panel 420a based on preconfigured workflow and country rules for at least one of the asset type 220 and the open task 270. In the example illustrated in FIG. 4B, the asset type 220 could be either patent or trademark, and because the open task 270 is ‘Non-Final OA Resp. Due’, one value for the drop-down 424 is ‘OA Resp. Filed Date’, indicating that user input into the metadata entry area 450a will signify a date on which the non-final office action was responded to. An additional value for the drop-down 424 could be ‘Instructions Sent Date’ to signify that user input into that metadata entry area 450a will denote a date on which instructions were sent to counsel to respond to the non-final office action. While the above examples have been limited to date values, the drop-down 424 in the metadata entry area 450 could also be utilized with other types of data, such as numbers and/or text strings.

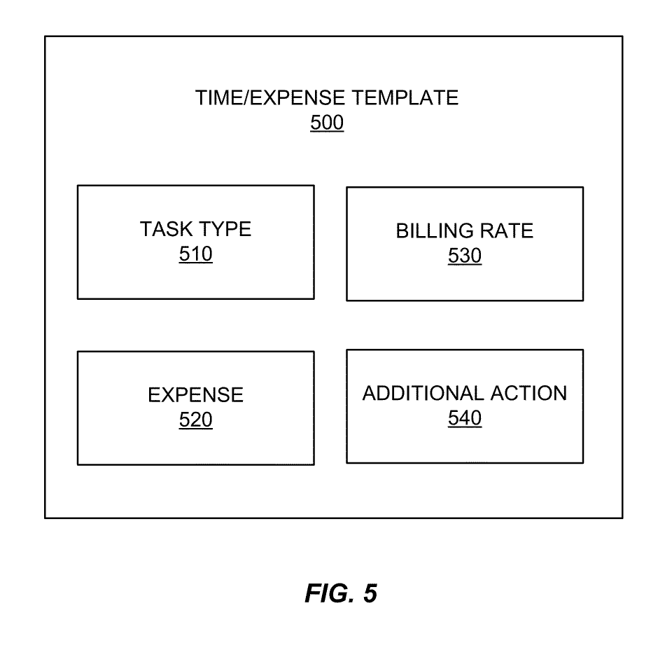

Turning now to FIG. 5, details of a time/expense template 500 are disclosed. The time/expense template 500 may be used to create the time/expense entry 280. The IAM user, through an interface to the IAM server, may configure and edit the time/expense template 500, and an IAM server may include multiple time/expense templates 500, each with different values therein. The time/expense entry 280 can be created by the IAM user or automatically by the IAM server 130. In either case, a time/expense template 500 may be used to create the time/expense entry 280. As illustrated in FIG. 5, the time/expense template 500 may include a task type 510, an expense 520, a billing rate 530, and an additional action 540, among other possible items. Each of these units will be briefly discussed below. When the IAM user or the IAM server 130 utilizes the time/expense template 500 to create the time/expense entry 280, one or more of the values of the time/expense template 500 are used for the time/expense entry 280.

With respect to the embodiment illustrated in FIG. 5, the task type 510 is utilized by the IAM server 130 to match to the task 270 being closed in order to determine what subsequent steps should be performed based on other units of the time/expense template 500.

The expense 520 may comprise a predetermined monetary amount, in any currency, associated with the task 270 referenced by the task type 510, an expense code, and an expense description. The expense 520 could represent, for example, a Uniform Task-Based Management System (UTBMS) code, such as “E108” for Postage expenses. The expense 520 could alternatively represent a patent office filing fee or other government fee. The expense 520 may be a plurality of expenses 520. That is, multiple expenses 520 may be, and commonly are, associated with the time/expense template 500.

The billing rate 530 comprises information pertaining to how much will be charged for the services rendered in performance of the task 270 referenced by the task type 510. The billing rate 530 may, for example, include a predetermined fixed monetary amount in any currency, as in the case of a practitioner billing a fixed amount based on the completed task 270. Alternatively, the billing rate 530 may comprise a time unit (such as hourly) billing monetary amount, in any currency, instead of a fixed monetary amount. Additionally, the billing rate 530 may also be based upon the asset type 220, the client 290, and/or the JAM user performing the work associated with the task 270. That is, a billable monetary amount can be determined based on multiple variables as defined by the billing rate 530. For example, a given patent attorney may bill client entity “A” a fixed amount for the task 270, while the same patent attorney bills client entity “B” hourly for the same task 270, and furthermore the same patent attorney could bill client entity “C” a different fixed amount than the fixed amount billed client entity “A” even though performing the same task 270. The billing rate 530 also may include a time code, where the time code could represent, for example, a UTBMS code such as “A103” for drafting and revising activities.

The additional action 540 denotes predetermined additional steps that should be taken upon closure of the task 270 referenced by the task type 510. For example, upon task 270 closure, the additional action 540 could denote to construct and send a bill for completion of the task 270, where details of the bill can be determined, at least in part, by the billing rate 530. Other example actions that the additional action 540 could denote are opening an additional task and sending a message such as an electronic mail (email). For example, closure of task 270 could trigger a new task and/or an email to a billing manager to invoice the client entity referenced by the client 290. As for the billing rate 530, the additional action 540 may additionally be based upon the asset type 220, the client 290, and/or the JAM user performing the work associated with the task 270. For example, some client entities wish to be billed immediately upon task 270 completion. The additional action 540 may be a plurality of additional actions 540. That is, multiple additional actions 540 may be, and commonly are, associated with the time/expense template 500.

For a given task 270 for a given intellectual asset record 200, when the IAM user closes the given task 270 by entering data into the metadata entry area 450 associated with the drop-down 424 and selecting the save metadata UI object 426 (FIGS. 4A and 4B), the time/expense template 500 may be utilized by the IAM server 130 to create the time/expense entry 280 for the given intellectual asset record 200, as described in further detail below.

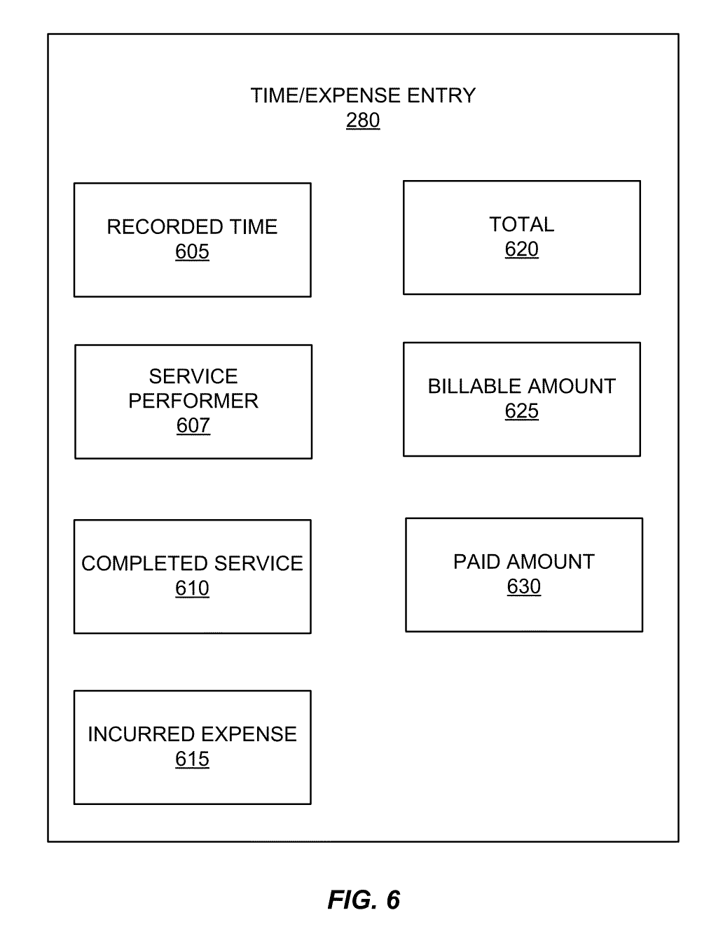

Turning now to FIG. 6, details of a time/expense entry 280 are disclosed. As described above, the time/expense entry 280 can be created by the IAM user or automatically by the IAM server 130. In either case, that is if the time/expense entry 280 is created by the IAM user or automatically by the IAM server 130, a time/expense template 500 (FIG. 5) may be used to create the time/expense entry 280. As illustrated in FIG. 6, the time/expense entry 280 may include any or all of a recorded time 605, a service performer 607, a completed service 610, an incurred expense 615, a total 620, a billable amount 625, and a paid amount 630, among other possible items. Each of these units will be briefly discussed below.

The recorded time 605 denotes a number of hours spent by the service performer 607 in completing the completed service 610. The completed service 610 denotes a job performed, and the job performed be represented by the task 270. The service performer 607 represents a person who has performed the completed service 610. The recorded time 605 may be entered by the IAM user or may be automatically recorded utilizing a stopwatch function (not shown) in tracking time spent by the service performer 607 on the completed service 610. The service performer 607 may be a plurality of service performers 607. That is, multiple service performers 607 may be, and commonly are, associated with the time/expense entry 280. Additionally, the completed service 610 may be a plurality of completed services 610. That is, multiple completed services 610 may be, and commonly are, associated with the time/expense entry 280.

The incurred expense 615 records an expense incurred in performance of the completed service 610, and the incurred expense 615 may comprises a monetary amount, an expense code and an expense description. The incurred expense 615 may be a plurality of incurred expenses 615. That is, multiple incurred expenses 615 may be, and commonly are, associated with the time/expense entry 280.

The total 620 denotes a total monetary amount calculated by adding charges for the completed service 610 with the incurred expense 615 or plurality of incurred expenses 615. As described in reference to FIG. 5, the billing rate 530 determines how to charge and how much is to be charged. The recorded time 605 can by multiplied against an hourly billable monetary amount of the billing rate 530 in calculating the total 620.

The IAM user may perform one or more modifications to the time/expense entry 280 prior to providing a bill to the client entity by marking up or down the total 620, writing off a portion of the total 620, or overriding or omitting an expense. The billable amount 625 denotes the portion of the total 620 that is actually to be billed to the client entity. The paid amount 630 denotes the amount or portion of the billable amount 625 that has been recorded as paid by the client entity.

One or more time/expense entries 280 may be grouped together into a single bill provided to the client entity, and the total billable amounts 620 from each time/expense entry 280 may be added together to formulate one overall bill total. The single bill may be sent automatically upon task completion, or may be designated as requiring review, possible editing, and acceptance prior to submission to the client entity.

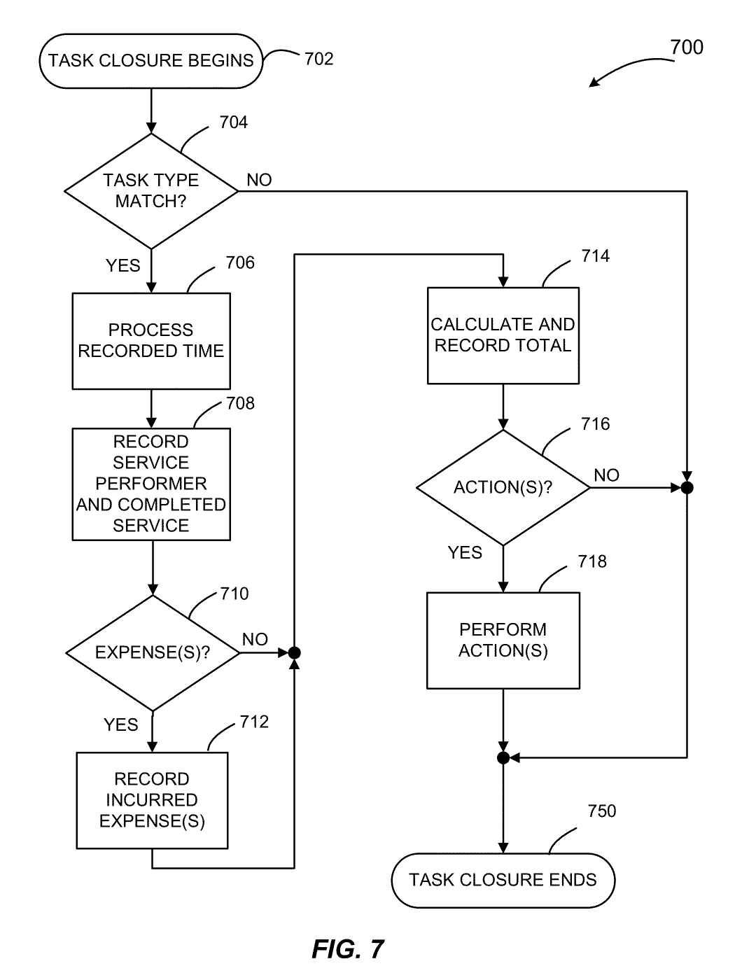

Turning next to FIG. 7 in combination with FIGS. 5 and 6, additional details of a method for processing closure of the task 270 to create the time/expense entry 280 are disclosed. Referring to FIG. 7, a flow diagram is provided depicting an example method 700 for automatically creating the time/expense entry 280 for intellectual asset record 200 upon closure of the task 270. The time/expense entry creation process 700 may be performed by an electronic device, such as the IAM server 130.

At 702 the time/expense entry creation process 700 begins upon closure of the task 270. At step 704 the controller 132 of the IAM server 130 compares the task 270 to the task type 510 of the time/expense template 500. If a match is found at step 704, then the controller 132 processes the recorded time 605 for the time/expense entry 280 at step 706. The recorded time 605 processing may comprise prompting the IAM user to enter time spent on the task 270, or the controller 132 may automatically total time spent on the task 270 using a stopwatch function.

Then at step 708, the controller 132 records the service performer 607 in the time/expense entry 280 using information from the billing rate 530 and/or information associated with the IAM user closing the task 270, and the controller 132 also records the completed service 610 based on the task 270 being closed. If at step 710 there exists one or more expenses 520 in the time/expense template 500, then for each expense 520, the controller 132 records the incurred expense 615 at step 712.

At step 714 the controller 132 calculates and records the total 620 by adding the incurred expenses 615, if any, to the monetary amount determined by the billing rate 530, if any, of the time/expense template 500. As described above, the billing rate 530, may, for example, include a predetermined fixed monetary amount in any currency, as in the case of a practitioner billing a fixed amount based on the completed task 270. Alternatively, the billing rate 530 may comprise an hourly billing monetary amount, in which case the controller 132 multiplies the recorded time 605 by the hourly billing amount. Additionally, the billing rate 530 may also be based upon the asset type 220, the client 290, and/or the IAM user performing the work associated with the task 270. For an IAM user tracking only recorded time 605 and/or incurred expenses 615, such as an IAM user associated with a corporate entity where there is no client 290 to bill, there is no need for the billing rate 530. If only incurred expenses 615 are recorded, then the total 620 reflects only added incurred expenses 615.

If at step 716 one or more additional actions 540 from the time/expense template 500 exist, then at step 718 the controller 132 performs the additional steps that should be taken upon closure of the task 270 as denoted by the one or more additional actions 540. The time/expense entry creation upon task 270 closure process 700 ends at 750 and is considered completed.

The time/expense entry creation process 700 automatically creates the time/expense entry 280 for the IA record 200 for any type of client entity-instructed tasks such as, but not limited to, drafting, filing, prosecution, validating, searching, and analyzing, thereby reducing IAM user data entry work and reducing data recording errors. Automatic creation of the time/expense entry 280 can be useful for, among other scenarios, default time entries for flat-fee tasks, default expense entries for government fees, and immediate billing.

As an example, for an intellectual asset record 200 with the asset type 220 denoting a patent asset, upon task 270 closure wherein the task 270 is to file a patent application, a first time/expense entry 280 is recorded for the time spent by a first service performer 607—in this case, the patent attorney who drafted and filed the patent application, recorded as the completed service 610. The patent attorney could charge a flat fee for patent drafting and filing, in which case the recorded time 605 would be optional, and there would not need to be the incurred expense 615 in the first time/expense entry 280, but the total 620 reflects the flat fee for patent filing. A second time/expense entry 280 is recorded for the time spent by a second service performer 607—in this case, the patent paralegal who electronically filed the patent application, recorded as the completed service 610. The patent paralegal may have an hourly billing amount as denoted by the billing rate 530, so time spent and recorded in the recorded time 605 is multiplied by the hourly billing amount from the billing rate 530 to calculate and record the total 620. There would not need to be the incurred expense 615 for the second time/expense entry 280. A third time/expense entry 280 is recorded for patent filing fees charged by a patent office and the incurred expense 615 is recorded from the expense 520 of the time/expense template 500. The total 620 is recorded as the amount from the incurred expense 615. In this example, three separate time/expense entries 280 are created and stored in the intellectual asset 200, but alternatively all time and expense information could have instead been recorded within one time/expense entry 280 with two recorded times 605, two service performers 607, two completed services 610, one incurred expense 615 and one total 620.

The embodiments described herein may include the use of a special purpose or general-purpose computer including various computer hardware or software modules, as discussed in greater detail below.

Embodiments within the scope of the present subject matter also include tangible computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system, methods, and other means for accomplishing functions disclosed herein are preferably implemented in software, implementations in hardware or a combination of software and hardware are also possible and contemplated. In this description, a “computing entity” may be any computing system as previously defined herein, or any module or combination of modulates running on a computing system.

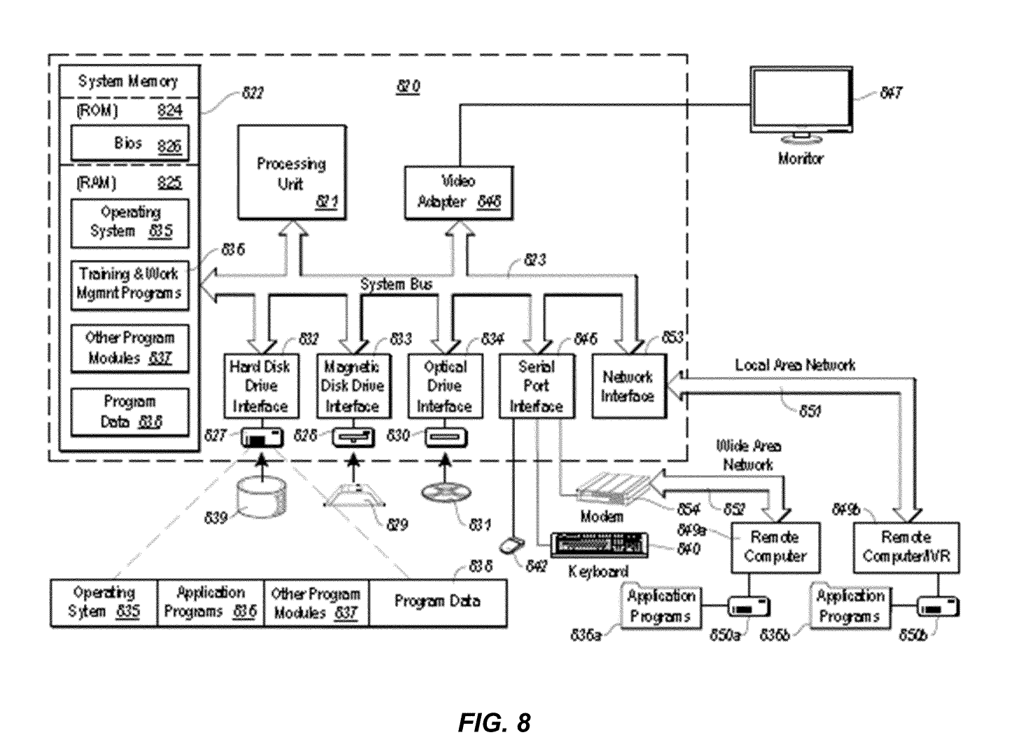

FIG. 8 and the following discussion are intended to provide a brief, general description of a suitable computing environment in which several embodiments may be implemented. For example FIG. 8 may illustrate an example of various components of an IAM server, a user device, a controller, or a memory device. FIG. 8 can also illustrate a means and steps for accomplishing various functionality and acts disclosed herein. For example, FIG. 8 as a specially programmed computer can create a time and/or expense entry upon closure of a task for an intellectual asset record as well as other acts and algorithms disclosed herein. Although not required, several embodiments will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps disclosed herein.

Those skilled in the art will appreciate that the embodiments illustrated herein may be practiced in network computing environments with many types of computer system configurations, including personal computers, hand-held devices, multi-processor systems, microprocessor-based or programmable consumer electronics, network PCs, minicomputers, mainframe computers, and the like. Several embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an example of an IAM system 100 for implementing several embodiments is illustrated, which includes a general purpose computing device in the form of a conventional computer 820, including a processing unit 821, a system memory 822, and a system bus 823 that couples various system components including the system memory 822 to the processing unit 821. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824. Such components, or similar components, may also embody a workstation for a company representative.

The computer 820 may also include a magnetic hard disk drive 827 for reading from and writing to a magnetic hard disk 839, a magnetic disk drive 828 for reading from or writing to a removable magnetic disk 829, and an optical disk drive 830 for reading from or writing to removable optical disk 831 such as a CD-ROM, DVD, or other optical media. The magnetic hard disk drive 827, magnetic disk drive 828, and optical disk drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the environment described herein employs a magnetic hard disk 839, a removable magnetic disk 829 and a removable optical disk 831, other types of computer readable media for storing data can be used, including magnetic cassettes, flash memory cards, digital versatile disks, Bernoulli cartridges, RAMs, ROMs, millipede memory, and the like.

Program code means comprising one or more program modules may be stored on the hard disk 839, magnetic disk 829, optical disk 831, ROM 824 or RAM 825, including an operating system 835, one or more training and work management programs 836, other program modules 837, and program data 838, such as company representative proficiencies and status. A user may enter commands and information into the computer 820 through keyboard 840, pointing device 842, or other input devices (not shown), such as a microphone, joy stick, game pad, satellite dish, scanner, or the like. These and other input devices are often connected to the processing unit 821 through a serial port interface 846 coupled to system bus 823. Alternatively, the input devices may be connected by other interfaces, such as a parallel port, a game port, or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, workstations of company representatives, a peer device or other common network node, and typically include many or all of the elements described above relative to the computer 820, although only memory storage devices 850a and 850b and their associated application programs 836a and 836b have been illustrated in FIG. 8. The logical connections depicted in FIG. 8 include a LAN 851 and a WAN 852 that are presented here by way of example and not limitation. Such networking environments are commonplace in office-wide or enterprise-wide computer networks, intranets and the internet.

When used in a LAN networking environment, the computer 820 is connected to the local network 851 through a network interface or adapter 853. When used in a WAN networking environment, the computer 820 may include a modem 854, a wireless link, or other means for establishing communications over the wide area network 852, such as the internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are example and other means exist for establishing communications over wide area network 852.

The previously described embodiments have many advantages, including simplifying creation of time and/or expense entries for intellectual asset records, reducing IAM user data entry work, and improving data integrity. All advantageous features and all advantages need not be incorporated into every embodiment.

The present subject matter of the present application may be embodied in other specific forms without departing from its spirit or essential characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A method of creating a time/expense entry for an intellectual asset record stored within an intellectual asset management system, the method comprising:
detecting closure of a task associated with the intellectual asset record;
comparing a task type of a time/expense template to the task;
determining a match of the task type to the task; and
in response to determining the match, creating a time/expense entry for the intellectual asset record.

2. The method of claim 1, further comprising utilizing one or more time/expense template units, in addition to the task type, in creation of the time/expense entry.

3. The method of claim 2, wherein the one or more time/expense template units comprise at least one of an expense, a billing rate, and an additional action.

4. The method of claim 3, wherein the billing rate comprises an amount to charge for services rendered in performance of the task matched to the task type of the time/expense template.

5. The method of claim 4, wherein the billing rate comprises one of a fixed monetary amount and a time unit monetary amount.

6. The method of claim 3, further comprising performing one or more predetermined additional steps upon closure of the task, as defined by the additional action.

7. The method of claim 6, wherein the one or more predetermined additional steps comprise at least one of constructing a bill, sending a message, and opening a new task.

8. The method of claim 6, wherein the one or more predetermined additional steps are further determined by at least one of an intellectual asset type, a client, and the service performer.

9. The method of claim 1, wherein the time/expense entry for the intellectual asset record comprises at least one of a recorded time, a service performer, a completed service, an incurred expense, a total, a billable amount, and a paid amount.

10. The method of claim 9, further comprising calculating the total using the billing rate, wherein the billing rate is based upon at least one of an intellectual asset type, a client, and the service performer.

11. The method of claim 1, further comprising constructing a bill using values from the time/expense entry.

12. The method of claim 11, further comprising one of sending the bill to a client entity and designating that the bill requires review.

13. A computer storage medium having computer executable instructions stored thereon for performing the method of claim 1.

14. An intellectual asset management (IAM) server comprising:
at least one memory device for storing one or more intellectual asset records; and
a controller operatively connected to the at least one memory device, wherein the controller is configured to:
detect closure of a task associated with an intellectual asset record, compare a task type of a time/expense template to the task,
determine a match of the task type to the task, and
in response to determining the match, create a time/expense entry for the intellectual asset record.

15. The IAM server of claim 14, wherein the controller further utilizes one or more time/expense template units, in addition to the task type, in creation of the time/expense entry.

16. The IAM server of claim 15, wherein the one or more time/expense template units comprise at least one of an expense, a billing rate, and an additional action.

17. The IAM server of claim 16, wherein the billing rate comprises an amount to charge for services rendered in performance of the task matched to the task type of the time/expense template.

18. The IAM server of claim 17, wherein the billing rate comprises one of a fixed monetary amount and a time unit monetary amount.

19. The IAM server of claim 16, wherein the controller further performs one or more predetermined additional steps upon closure of the task, as defined by the additional action.

20. The IAM server of claim 19, wherein the one or more predetermined additional steps comprise at least one of constructing a bill, sending a message, and opening a new task.

21. The IAM server of claim 19, wherein the one or more predetermined additional steps are further determined by at least one of an intellectual asset type, a client, and the service performer.

22. The IAM server of claim 14, wherein the time/expense entry for the intellectual asset record comprises at least one of a recorded time, a service performer, a completed service, an incurred expense, a total, a billable amount, and a paid amount.

23. The IAM server of claim 22, wherein the controller further calculates the total using the billing rate, wherein the billing rate is based upon at least one of an intellectual asset type, a client, and the service performer.

24. The IAM server of claim 14, wherein the controller further constructs a bill using values from the time/expense entry.

25. The IAM server of claim 24, wherein the controller further performs one of sending the bill to a client entity and designating that the bill requires review.
